(19) United States
(12) Patent Application Publication
(10) Pub. No.: US 2023/0169477 A1
(43) Pub. Date: Jun. 1, 2023

(54) Offline in-person monetary transfer (OIMT)

(71) Applicant: Scott Trinder, Vancouver (CA)

(72) Inventor: Scott Trinder, Vancouver (CA)

(21) Appl. No.: 17/833,844

(22) Filed: Jun. 6, 2022

Related U.S. Application Data
(60) Provisional application No. 63/258,918, filed on Jun. 7, 2021.

(51) Int. Cl. G06Q 20/10; G06Q 20/32; G06Q 20/40

(52) U.S. Cl. CPC G06Q 20/102; G06Q 20/3278; G06Q 20/40145

(57) ABSTRACT

OFFLINE IN-PERSON MONETARY TRANSFER (OIMT) similar to cash facilitates the exchange of digital cash, data or other currencies between 2-people IN-PERSON and in-close-proximity OFFLINE without the need to share any personal or private information. No server connection or internet is required at the time of transfer. OIMT (Offline In-person monetary transfer). Methods and systems included here in: In one embodiment of the OIMT system a maximum of two people and their communications devices connect off-line with SVK's (Single-use Verification Key) via short range communication such as NFC (Near-Field Communication) within e.g. several feet or inches of each other. The SVK and the requirement for additional random SVK numbers and or letters and or symbols to be entered by the sender or randomly generated at the time (via a Random Number Generator or Random Number Letter Symbol Generator) of transfer allows for two strangers devices to VKL (Verified Key Lock) (FIG. 2b-Block 7) in-person without the sharing of any personal information PIPS (Personal Identity Protective Software) such as e.g. email or phone number or bank information. Another embodiment enables currency to be loaded onto the communication device that resides in a separate partition or folder from the SVK keys. The SVK's link to the specific denomination the sender inputs for transfer. Once the additional numbers and or letters and or symbols are shared with the receiver in-person either visually or spoken from the sender the receiver enters them (the exact digits provided by the sender) in their device the receiver's communication device will also link to the denomination upon VKL. The OIMT invention incorporates some or multiple sensor data into the SVK such as e.g. GPS, Motion, Light, Biometric, Gyroscopic, GPS etc.. to assist in the verification process. After the denomination is (FIG. 2—Block 1) entered and the SVK's additional numbers or letters or symbols have been inputted and the VKL has verified; and a countdown timer (FIG. 2—Block 8) or clock or measuring info graphic initiates—another embodiment is the physical action required by both sender and receiver upon a (FIG. 2—Block 10) PGUI (Physical Graphical User Interface) in person-to-person proximity to facilitate the transfer of currency within e.g. within a few feet, inches or centimeters (FIG. 2e—Block 33) of each other's device (using NFC or other short range communication) and within a set period of time shown by a timer which initiates on VKL (FIG. 2—Block 8) for which the transfer must occur within. The sender must physically act upon a PGUI such as a slider bar to transfer the funds half way out of their (FIG. 2—Block 11) device during the transfer. During the physical action the sender and receiver are made aware the transfer is occurring by (FIG. 2f) a visual reference on their device and possibly additional haptic and or physical and or audible alerts. Once funds are transferred halfway out of the senders device the receiver is prompted to interact with their PGUI e.g. slider bar to pull the funds into their device while also receiving visual (FIG. 2—Block 11b) and or physical and or audible alerts ensuring the receiver is aware they are participating in an OIMT (offline in person monetary transfer). This innovation includes a SVK reconciliation process that occurs after the funds transfer has occurred. The transfer process does not require a server or internet connection however the reconciliation process which occurs later-on requires an Internet connection to complete. The initial loading of funds and SVK's requires an internet connection. NOTE: Internet and or server connections are NOT required at the time of the currency transfer. A transfer can happen between two people anywhere on the earth, planet(s), outer space, ocean(s), sky(s) as long as SVK's and monetary, data currency, are preloaded on the senders' device. The receiver only requires SVK's to receive currency.

OIMT (Offline in-person monetary transfer)

SVK (Single-use Verification Key)

VKL (Verified Key Lock)

PIPS (Personal Identity Protective Software)

SDI: (SVK-Dynamic Incorporation)

PGUI (Physical Graphical User Interface)

### FIELD OF INVENTION

The current invention relates to Offline In-Person peer-to-peer electronic monetary, currency and data transfers between two mobile communication devices that are within close proximity e.g. centimeters apart with systems and methods that enable the transfer to occur in-person-and-offline in close person-to-person proximity (e.g. within several inches or centimeters of each other) without the need for data, Wi-Fi or internet. More specifically the embodiments provide details as to how the back-end systems' enable the OIMT (offline In-person Monetary Transfer) to occur. The technology enables users to complete a financial, monetary, currency data transactions in locations where there is no Internet connection and also eliminates the requirement for live server system authorization and authentication to complete a person-to-person transaction at the time of transfer. One large limitation with traditional mobile monetary, finance, currency transfer systems is they rely on such server systems to authenticate. This invention enables people with smart phones who do-not-have mobile data to participate in financial and currency transactions anywhere anytime as long as they (in advance) have preloaded Cash and SVK's (Single-us Verification Keys) loaded onto their device through an internet source for example at home prior to heading-out for the day.

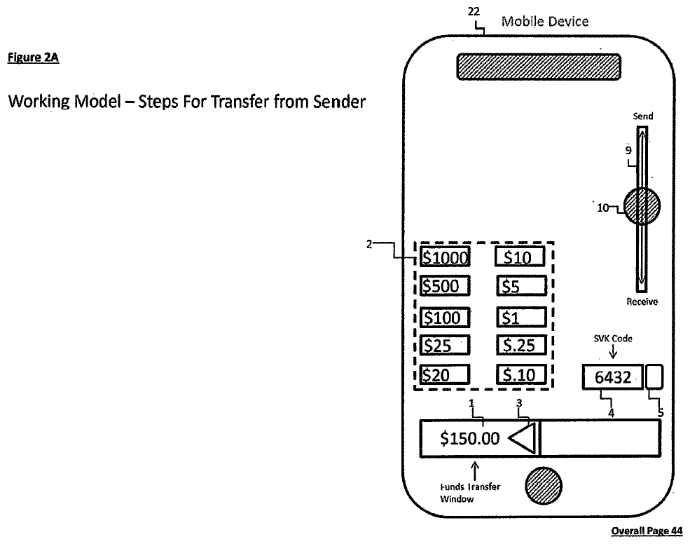

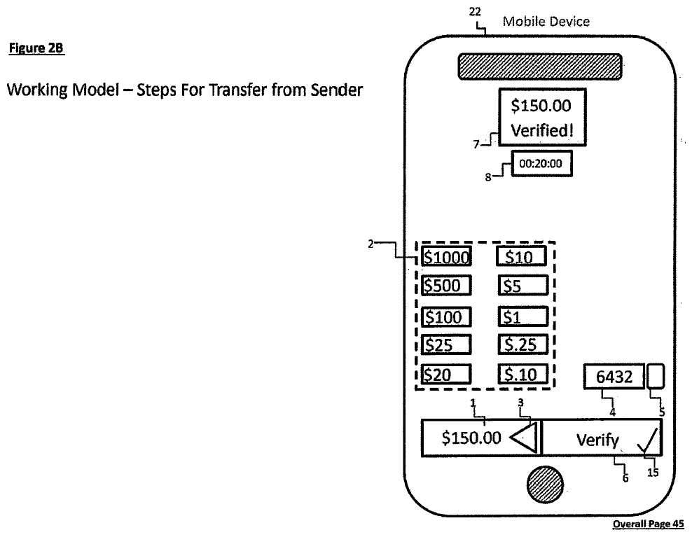

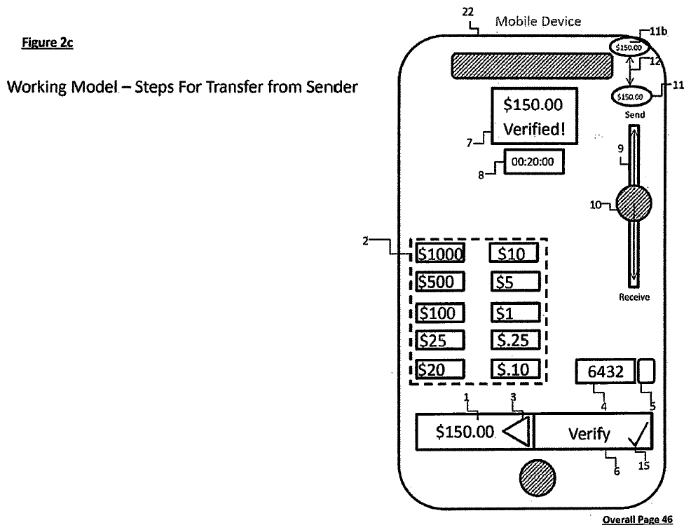

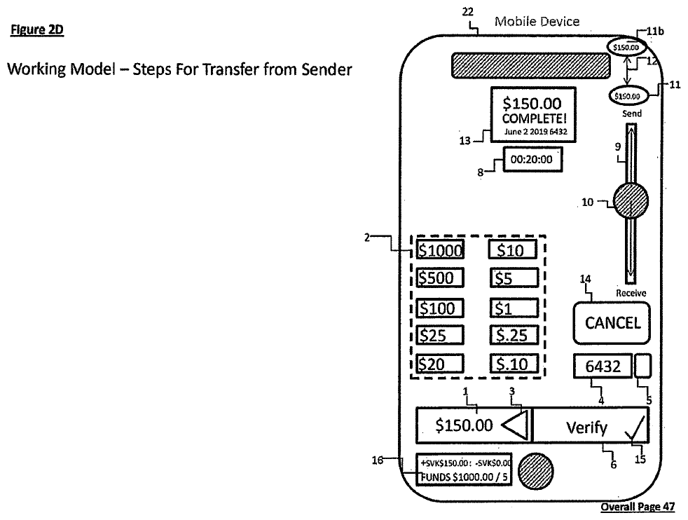

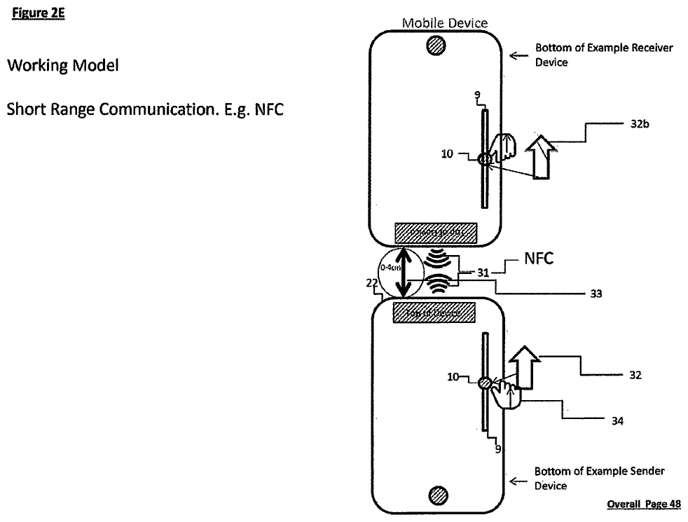

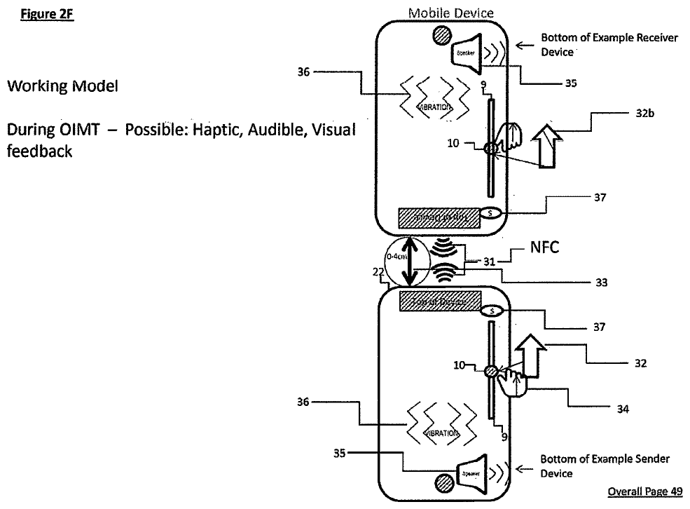

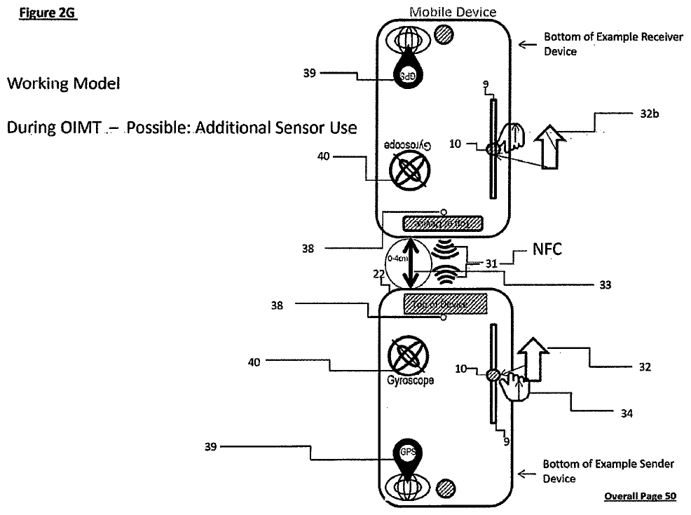

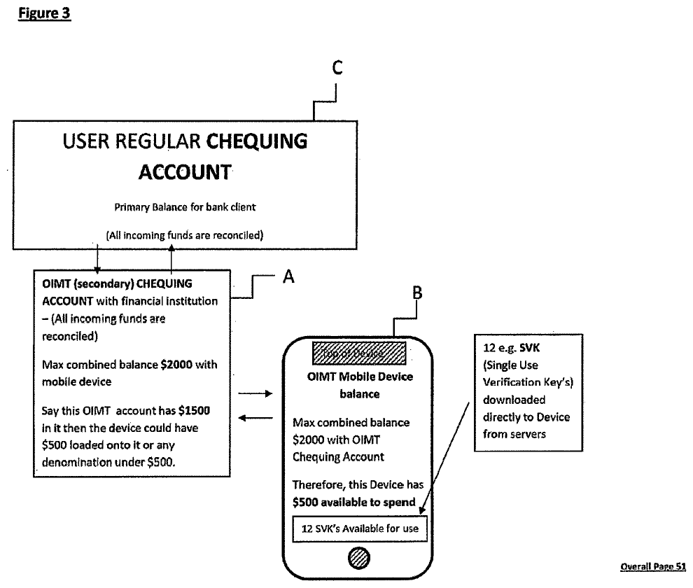

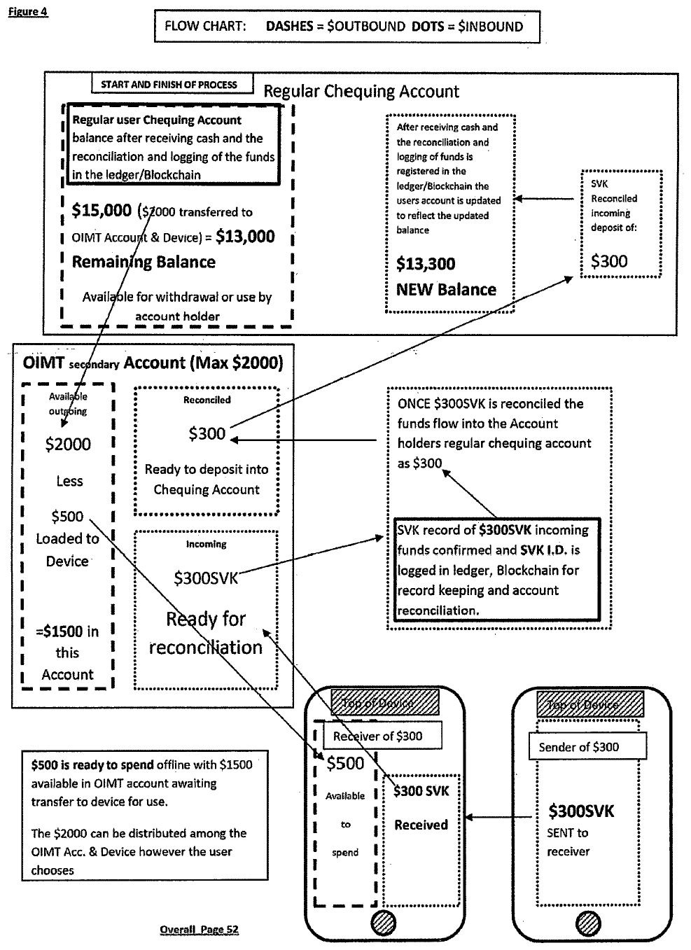

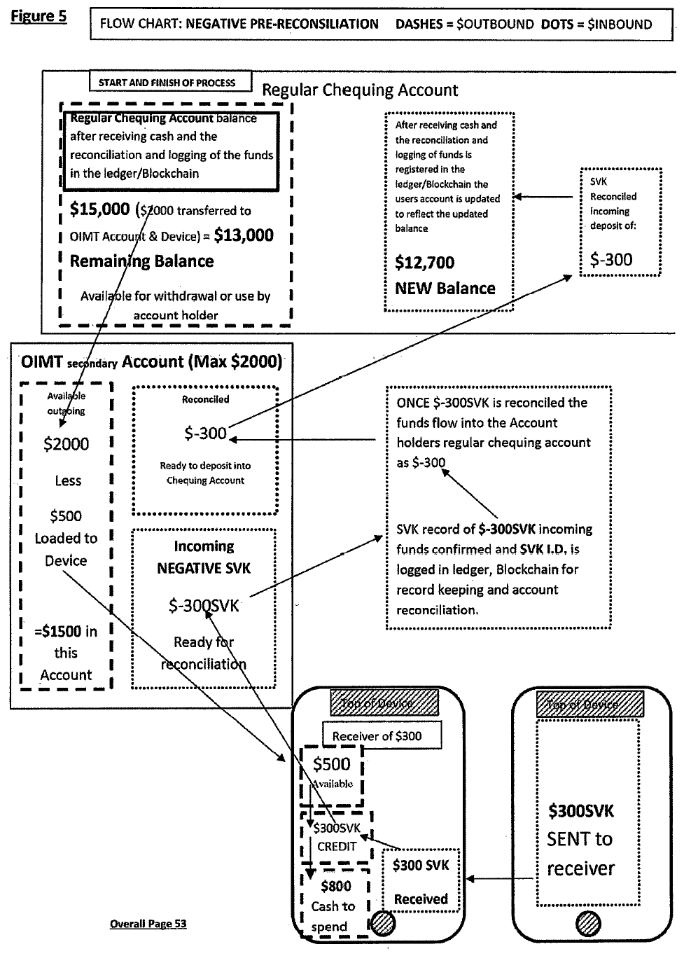

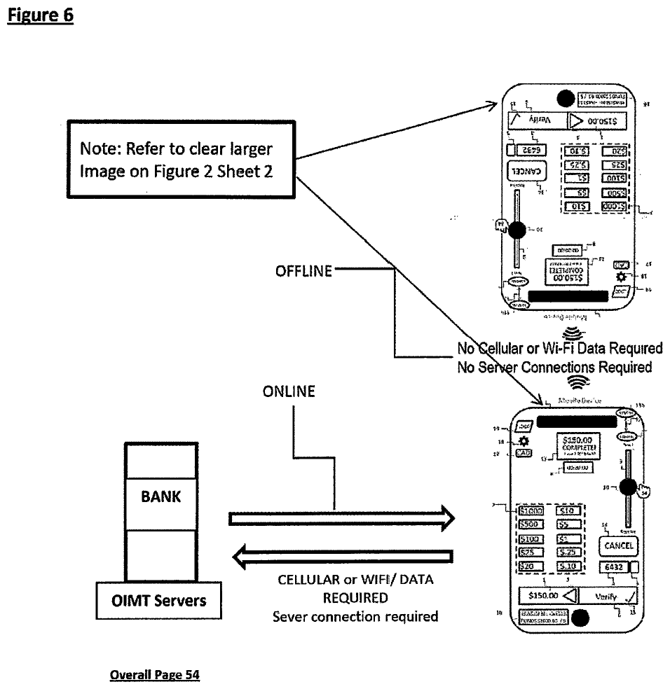

The current invention relates to electronic monetary and data transfers between two mobile communication devices using Single-use Verified Keys (SVK) or other encrypted software using multiple digits, codes or other secure means that can link solely between no-more than 2 communications devices via NFC (Near-Field Communication) or other close range mobile communication technologies. The OFFLINE transfer (Offline In-person Monetary Transfer—OIMT) between devices can occur offline without the need for server, internet, Wi-Fi or external source data connections and more specifically, to methods and systems; requires the sender to make up a random selection of e.g. numeric digits, letters or symbols (FIG. 2—Block 4: SVK) to be shared IN-PERSON with the receiver via visual ques from the device, spoken word, hand written note or other in-person means. Following the senders device verifying the code communicated by the receivers' device VKL ‘Verified Key Lock’ verification occurs. Upon VKL verification there is a time limit to complete the physical transfer or the SVK key will expire and possibly destruct or be logged with a zero balance. A physical interaction initiated by the sender via a PGUI (FIG. 2—Block 10: Physical Graphical User Interface) with motion upon the mobile communication device with an integrated PGUI feature for example a digital image of a slide bar, button or toggle which may in simultaneous conjunction produces audible sound, graphical visual, and haptic physical feedback the sender is made aware by these ques that they are in the process of transferring money/data currency while simultaneously the receiver of the receiving wireless communication device also requires a physical motion within the set period of time (FIG. 2—Block 8: indicated on their device) that indicates their intent to receive the monetary/data being sent. The receivers personal physical action sliding the slide bar, push button, or other method of tactile PGUI action occurs with possibly the same Audible, Visual, and Physical sensor feedback so the receiver is physically aware they and their device is receiving the monetary amount/data currency being transferred from the senders communication device during the Offline In-person Monetary Transfer—(OIMT) process.

OIMT (Offline in-person monetary transfer)

SVK (Single-use Verification Key)

VKL (Verified Key Lock)

PIPS (Personal Identity Protective Software)

SDI: (SVK-Dynamic Incorporation)

PGUI (Physical Graphical User Interface)

### BACKGROUND OF INVENTION P1

Electronic monetary and data transfer systems are constantly being developed and enhanced as technology in the fintech payments field rapidly advances. This evolution requires more data to facilitate transactions and often requires users to obtain mobile data or be forced to use non-secure Wi-Fi networks to facilitate a mobile currency or other monetary transactions. For example when one Apple Pay user wants to send cash to another Apple Pay user via their mobile device (excluding retail merchant machines) the sender must send it through iMessage and in doing so they share their email or phone number with the receiver. iMessage is Apples messaging app that requires Data or an internet connection to function. https://support.apple.com/en-ca/guide/iphone/iph6d80edff1/14.0/ios/14.0. Apple's system also does not require the Sender or receiver to be in-person like OIMT. The in-person person-to-person requirement of a OIMT transaction to facilitate is a fundamental embodiment. In addition the sharing of private and personal information can expose individuals to fraud. Many financial transaction technologies require an individual to share a phone number or email or bank information to conduct a monetary data transfer between two people. This invention (OIMT) and the subsequent technology protects the privacy of the individuals as no personal information is exchanged.

Although this invention was envisioned prior to the global pandemic (because my children do not have data) the recent bank closures and reduction in acceptance of cash and the reduced use of cash in general has highlighted the need for this form of off-line payment service. Recently, one local bank removed all tellers and the handling of cash completely. Another bank closed altogether and also removed the ATM. These developments have marginalized not only my kids but many in our community and society from easy access to cash and the banking industry in general. This invention solves these problems as simple transactions have become challenging for many people especially for those who cannot afford data and the financial technology that requires data to enable their use. The current peer-to-peer mobile payment systems leave out large sections of the population where cash is a necessity in day-to-day life. This invention provides those who would otherwise be left out of the emergence of online financial, monetary and currency transitions an opportunity to participate in the digital in-person, person-to-person payment space without the added costs of data or the use of public Wi-Fi. This invention frees such people from the burdens associated with traditional systems and infrastructure which rely on data and internet connections when they are out of their homes and need to conduct in a financial exchange with another person. This invention also eliminates the sharing of private and personal information when transacting with a stranger during a purchase at for example a swap meet or when making a craigslist purchase.

This invention has been created to address the ever changing way cash, currency is being used in global societies and nations. Many nations are looking to eliminate physical cash and replace it with a form of digital/data monetary currency, crypto. Enhancements in mobile communication device technologies and the sensor capabilities and encrypted means to transfer data within them provide opportunities for more sophisticated solutions in this space. Many solutions require data and or the sharing of personal information to conduct peer-to-peer monetary, currency transactions. For example a group of banks in Sweden launched a digital payment service called Swish. Swish requires users to share their phone number to facilitate an in-person, person-to-person transaction which is an integral part of a person's personal information and private data. Swish also requires use of the phone system. https://en.wikipedia.org/wiki/Swish (payment)

People who transfer money with e-transfers also require data and the sharing of their email and other personal data.

### BACKGROUND OF INVENTION P2

Another key aspect to this invention is privacy. This invention does not require the user to share their personal information e.g. phone number, email, or banking information with strangers. Therefore, a user of this invention can feel secure that when they buy an item off craigslist or at a flea-market from a stranger their personal information is not being shared with the other party to the transaction.

This invention overcomes the draw-backs of the current financial system and its network and data requirements that create barriers for many people either young or whom cannot afford data. Therefore offering these people with a private, secure and physical cash transfer option that functions just like cash between no more than two communication devices without the requirement for data. This invention will be invaluable to such people and will allow them to participate in society from a financial standpoint in a more integrated and meaningful way.

NOTE: Data or Wi-Fi from a trusted source is required to pre-load both money, currency, data and SVK single-use verification keys onto the users' devices in advance of any future transactions. SVK's will remain on the device until they are summoned for use. As long as the user has some SVK's on their device they will not need Cash loaded to receive money, currency or data, however, both SVK's and Cash will need to be loaded onto the user device in advance for them to make a purchase. With cash and SVK's preloaded the user can make an OIMT Offline In-Person Monetary Transfer anywhere anytime with no cellular data or Wi-Fi connection. This feature enables the invention to function just like cash.

The privacy that actual physical cash offers has been lost in many payment applications. This invention allows 2 strangers to participate in an OIMT off-line in-person monetary transfer anonymously with each other. Many digital payment technologies require 2 strangers to share a phone number, email or other private information with the other party to facilitate a transaction. This invention brings-back the essence of cash and allows a youth to buy a skateboard at a swap-meet off a stranger anonymously without giving up key elements of their personal information. As mentioned above it appears that SWISH requires the use of the Sender and Receivers phone numbers to be shared for in-person cash transactions. https://en.wikipedia.org/wiki/Swish (payment)

In addition this technology provides a layer of protection from ones bank account as the funds or currency available may be limited to a maximum daily value (e.g.$2000) and must first be withdrawn from the users account and deposited into a specific account and or the technology prior to use. The SVK Single-use Verification Keys will be loaded separately into the device and will only encrypt and fund a transfer when the VKL verified Key Lock process has been initiated by the users.

In today's modern fintech world the banks and other financial institutions are looking for ways to reduce the use-of or eliminate the use-of cash. See Video: (https://www.youtube.com/watch?v=GbECT1J9bXg—See Reference Page 1—A) This invention will enable banks, financial, currency institutions and governments the ability to ween society off cash. This invention will enable the transition off cash for small transactions to occur more seamlessly between two people. Providing up to a reasonable amount of cash e.g. $2000 per day (an amount which could be regulated) of available digital cash that can be spent without a record of what was purchased will provide the public with the essence of cash and the empowerment of a level of privacy. A key element of this invention is the ability for transactional user privacy with the other party during the OIMT. In-addition the benefit to governments and the financial industry are that all moneys spent or received may flow through the users' personal bank account which may therefore add a layer of oversight as to how much money is being spent and received. This feature will aid in the prevention of money laundering. The flow of money can be referenced in FIG. S. 4 and 5 within this document.

### BACKGROUND OF INVENTION P3

With Power essential to completing online monetary transfers and even ATM cash withdraws; the current global system is not prepared for a natural disaster. Even cash will be unavailable to the public as ATM machines will be rendered inoperable. This invention enables users that have SVK's and or Cash on their communications devices the ability to make financial transactions offline during a major disaster which either interrupts the power supply, internet connection, or both. In an emergency scenario this invention and the SVK's can be enabled for a user to spend incoming funds prior to a credit reconciliation server side. In such an emergency when servers, power or banking infrastructure is restored all such transactions where incoming funds were spent prior to reconciliation the SVK will reconcile upon the next data connection with a debit balance into the users account—FIG. 5. The option to spend incoming SVK's may also occur if the user establishes margin with their financial institution up to the maximum daily use.

In today's society where a person's data is of high value to nefarious players people do not want to share key elements of their data such as email, phone numbers or banking information with a stranger. This invention allows each individual the convenience of participating in an OIMT Offline In-Person Monetary Transfer without the potential risks associated to giving another person or stranger any personal information. The in-person requirement, close proximity, creation of additional or randomly generated (FIG. 2—Blocks 4 & 5) SVK numeric digits, alpha, or symbols prior to transfer combined with a (FIG. 2—Block 8) timer and the physical actions that must occur on both devices using the (FIG. 2-10) PGUI and any other sensor confirmation data all lead to enhance the users' security as they are participating in the OIMT transfer directly and in-person with the other party to the transfer.

The requirement for both people to be within a few feet of each other and for their devices to be within centimeters of each other (using NFC or other secure short range communication) while incorporating other security measures such as the SVK codes additional random characters within a time limited period and also incorporating other sensor e.g. GPS, Phone orientation, light sensor data, gyroscope, accelerometer (tap devices) and biometric data etc . . . will make in-person transactions between the 2 individuals difficult for outsiders to intercept or breach.

Most financial transfer apps enable 2-people to transfer money across huge distances which can prevent one party to the transaction from visibly identifying and confirming that the other person is who they intend to transfer money to. This invention functions in-person and there is no better way to confirm the other person is the person you want to transact with than doing the transfer in-person just like cash.

This invention is designed to bring modern fintech technology to the masses; it is designed to include those people who can't afford cellular data. It includes people who are apprehensive to use financial apps over public Wi-Fi, Wi-Fi which may not be available at a swap meet when they want to buy a skateboard or at other random geographical locations when needed. This invention empowers those who do not want to share private information such as their phone number or email or bank information with strangers. This invention is not limited by which smart phone each user has and the associated operating system and the limitations these systems may impose. For example Apple Pay is designed to work on their iMessage system for peer-to-peer transactions eliminating those who use android phones from participating in Apples financial technology.

### BACKGROUND OF INVENTION P4

This invention (OIMT) opens the door for mass adoption of a form of digital cash currency that breaks down the barriers which marginalize many in society. To bring private, secure, offline, person-to-person financial, currency, data transfer technology to the masses is the intent of this invention. There is also a method to incorporate pre-paid credit card/debit technology into the SVK system architecture and therefore enable offline transactions to occur peer-to-peer utilizing the existing banking infrastructure.

Another embodiment requires the sender to enter a small number of random numbers, letters or symbols that will be randomly or algorithmically added to the SVK. The Sender must share (show or speak) (FIG. 2—Block 4) these exact numbers or letters or symbols with the receiver so the receiver can enter the exact same numbers, letters, symbols into their SVK input PGUI. These additional numbers, letters or symbols may also be created through a (FIG. 2—Block 5) Random Number Generator at the time of transfer. The additional Numbers or Letters, or symbols generated by the user or randomly generated may have a defined meaning or randomized placement within existing SVK that is not visible or accessible to the sender or receiver. For example if one of the numbers chosen by the sender is the number 6 it may be placed in 12^{th} position in the SVK. Each number, letter or, symbol will be placed to enhance the security of the SVK. Another embodiment is the Physical action required by both sender and receiver upon a (FIG. 2—Block 10) PGUI to facilitate the transfer of currency in-person within e.g. a few feet of each other while their devices are held a few (FIG. 2f—Block 33) centimeters apart. Once the sender has inputted the currency amount and the additional SVK numbers and or letters and or symbols and have pushed the (FIG. 2—Block 6) verification button and VKL occurs and the timer begins the sender initiates the transfer physically by engaging with the (FIG. 2—Block 10) PGUI.

The SVK keys and offline and private transfer of currency could also be used by the global banking, finance and crypto industry to enable cash transactions to occur in person off-line and privately between two people whom have obtained pre-paid credit cards from their financial or currency institution. The SVK also has a feature that associates to an individual's prepaid credit card. When the OIMT occurs the Senders pre-paid card information will be encrypted into the SVK including the denomination of the funds sent upon VKL. The transfer occurs over NFC or other secure short range communication. Both the Senders and receivers SVK encrypted data will include the amount transferred the unique SVK characters entered and a unique or randomized code that links to their prepaid credit card upon a future internet connection the funds sent and received will reconcile server side and the receivers pre-paid credit card will be funded for the amount received through the industry standard refund process for credit card processing. Consumer rates may apply for the processing rather than retail rates, however the convenience and simplicity and mass adoption appeal for using the SVK and VKL and OIMT technology in conjunction with industry pre-paid credit card processing systems will make this option cost effective and will also enable banks and other currency institutions the ability to provide an added service that has mass appeal and convenience that may help these industries retain clients as the plethora of global fintech options continue to increase. This will also expand user participation to those who do not have data and whom do not want to share personal information with others.

Another problem with the existing system is common credit cards, pre-loaded credit cards, debit cards and gift cards are not designed for person-to-person financial transfers in-person. There is a wide open gap in the person-to-person monetary transfer system where those who are-not internet connected are forced to use traditional Cash, however, cash is becoming increasingly more difficult to transact with. OIMT bridges this gaping gap and enables those who are marginalized by the cost of data technology and who may be in a place where there is no access to Wi-fi with the ability to conduct person-to-person cash-like transactions offline anytime and anywhere.

OIMT is also a much safer option than carrying cash; as people won't be able to see how much cash you have.

### BACKGROUND OF INVENTION P5

Some examples of use include:

If two people are hiking and they do not have a data connection or Wi-Fi but want to participate in a financial exchange this technology would be available to them to do so as long as they have SVK's and Currency pre-loaded on their device's.

If a natural disaster occurs such as an earthquake where server systems are down and ATM's have no power and where access to cash is impossible. Those who have Cash and or SVK's preloaded on their device will be able to participate in financial transactions to buy necessities such as water and food. There is a provision for pre-reconciliation funds use to occur in such circumstances so that incoming funds can be spent prior to reconciliation. Any funds spent in this manor will reconcile with a negative SVK upon a future server connection.

A parent can easily transfer pocket money to a child for doing chore's should their child's device not have data.

When a person who does not have data is at a farmers market where there is no Wi-Fi and would like to pay cash OIMT will make this transfer safe, convenient, and easy.

When people go to a swapmeet or buy something off craigslist and want to maintain their privacy this invention enables a secure in-person, offline, and private means to conduct a cash-like transaction. Many current fintech technologies require the sharing of personal information such as email, phone number and or bank information. E-Transfers require email and Apple Pay transfers require iMessage between two people which also requires data and the other person to also have the same apple hardware device.

When a person comes home from a night out and needs to pay the babysitter this invention is perfect for such a simple cash-like transaction.

When a person needs to make a cash purchase but feels unsafe carrying cash this invention enables them to hold cash without other people seeing how much money they have. In addition their cash is locked in their device and all of the safety and security measure built into the SVK make it virtually impossible for a nefarious player to steel anyone's cash held within the OIMT infrastructure.

OIMT can be used on smart mobile devices with NFC and possibly other short range communications and can work across hardware platforms such as Android and Apple. In addition OIMT does not require users to share any personal information with each other to facilitate a funds, currency transfer. (There is an option for detailed receipts as an add on feature and randomized transactional recipes are provided) Furthermore OIMT does not require Data or Wi-Fi or a server connection to facilitate a transfer. Finally OIMT only occurs between two people in-person and in extreme close proximity. The OIMT solution functions—Just like cash.

### BACKGROUND OF INVENTION P6

OIMT is an offline mobile-electronic-device to mobile-electronic-device cash currency data transaction. (OIMT: Offline in-person Monetary Transfer)

The sender and the recipient must be within arms-length of each other to conduct a transfer.

Each user downloads country and or currency, crypto specific SVK's Single-Use Verification Keys in advance that are stored on their device to authenticate the cash, prepaid credit card, monetary, crypto or data transaction. SVK's may also be possibly configured for the private physical transfer of confidential data or trade secrets. (SVK: Single-use Verification Keys)

Encryption keys enable a secure in-person digital cash transaction from one device to ‘the’ another device in close proximity, in-person.

Cash or other forms of currency must also be downloaded onto the mobile communication device in addition to the SVK's.

When the sender designates and inputs the denomination to be sent to the receiver (the sender also enters a small number of numbers, letters or symbols e.g. a 3 or 4 digit code that they share visually or verbally with the receiver who then must also enter that code into their device. The codes are incorporated into each user (SVK) key randomly or algorithmically and secure the transaction between just those 2-devices through VKL Verified Key Lock and a (FIG. 2b- Block 7) VERFIED notification appears on both devices. This verifies the receivers' device is ready to receive the cash/data/currency and that they have an authenticated SVK encryption key handshake with the sender and that the senders device is ready to send cash/data/currency.

Once the receivers' device is verified a timer begins and the sender MUST physically act upon a (FIG. 2—Block 10) PGUI e.g. slide a transfer bar upward that may look like a volume bar. (The transfer occurs over short range communication such as NFC (FIG. 2f—Block 31) As the funds start to leave the top of the (FIG. 2—Block 11) senders device while the PGUI bar is being physically slid upward the Cash begins to appear in the receivers' device coming down from the top (FIG. 2—Block 11b) of their screen. Once the Cash is halfway between the two devices the receiver MUST physically slide their PGUI transfer bar down within the time allotted until the cash is registered as being (FIG. 2—Block 13) “Complete” on their mobile device. A confirmation which has no personal information other than the amount, day/time and possibly the additional SVK digits MAY be selected by the users. Users can also choose to customize receipts with more information should they choose to via an add-on.

Online Requirnments:

An online connection is required is when:
SVK's are downloaded
Country Specific Encryption keys are purchased
When Cash is downloaded from the users bank account to their phone (Reconciled and logged)
When Cash is uploaded back to the users bank account (Reconciled and logged)
Payment for the Applications transaction fees are due and payable
When the app or any add-ons are loaded onto the device
Other features may require an online connection

To facilitate the reconciliation of funds in the ledger or servers

### BACKGROUND OF INVENTION P7

SOLUTION—Security and Privacy:

Once cash is loaded on the mobile device and there are available (SVK) Single-use Verification Keys downloaded:
Transactions do not require an Internet connection
Transactions do not talk to a server or remote data center facility during the OIMT process.
Transactions do not share any personal information with the other device or 3^{rd} parties.
Transactions may use NFC in conjunction with sensors and are done only in person-to-person proximity
Transactions act like cash and have no record of the person you transacted with. There are generic receipts to prove the transaction occurred. Any additional receipt information is voluntarily shared through the addition of ad-on features.
The sender and receiver do not need to exchange any personal information to conduct a transaction they only need a valid SVK and cash and can select currency specific encryption keys.
There are no receipts—protections or refunds. Transactions occur ‘Just like cash’
Any detailed receipts must be written separately by the parties involved. ‘Just like cash’ or the use of add-on receipts available in the app can be used.
SVK NFC Transactions could occur with payment terminals in stores and could allow for cash in store purchases.
The only transactional amounts on record are when cash is placed in the application/mobile device from the bank as a withdrawal and when cash is loaded into the bank account from the device as a deposit.
Other currency or crypto providers may record these transactions uniquely.
There is no personal information on any auto generated transactional record for device to device cash transactions.
Cash and country specific encryption keys may be secured in two separate folders on the device.
Single use verification keys (SVK) are allocated to a single transaction.
Encryption keys may be single use currency specific and begin to time-out once a transaction is initiated.
Transactions do not require an online connection and only work person-to-person via short range communications for example NFC.
Transactions occur ‘just like cash’

### BACKGROUND OF INVENTION P8

BENEFITS:
Can be used in emergencies when there is no internet connection or power or access to servers.
Can be used in countries with limited mobile data/ Wi-Fi/internet availability
Facilitates cash transaction in emergencies ‘just like cash’
Maintains user privacy when purchasing items from strangers (i.e. Swap meet)
Allows anonymity for the self-regulated capped transactional amount up to $X (E.g. $2000)
As long as the device has power a transaction can occur anywhere>anytime
Transactions occur in the currency of the country where the bank account is registered
Transactions can include all currencies including crypto currencies.
Encryption keys are purchased in the currency required.
Transactions protect national currencies. This is not a currency. OIMT is a physical cash transaction facilitator
Any exchanges that require a conversion must use country specific encryption keys.
Both devices may require the same currency SVK for the SVK encryption key to ‘verify’
International encryption keys may be purchased during the day-of-use to reflect accurate exchange rates. These keys may expire after x-time (e.g. 24 hours).
It is envisioned that SVK's could reconcile exchange rates between different SVK currencies serer side post transaction.

### BACKGROUND OF INVENTION P9

DIFFERIENTATION—compared to other device to device financial exchange services:

Direct person-to-person offline cash transaction—People must participate physically to complete cash transaction—no internet or data required. Can be used in emergencies. No data center or servers are required to facilitate a transfer.
SVK Encryption keys authenticate with each other. This occurs digitally between devices.
The proprietary piece is the physical requirement for both the sender of cash/data and the receiver of cash/data to physically carry out the action. The action required by the sender occurs after the keys are verified and the cash is ready to be ‘handed/transferred’ to the receiver— the sender MUST physically slide a PGUI e.g. transfer bar upward on their device (haptic, 3d touch and other sensor technology will verify the physical transaction is occurring and provide tactile feedback during the transfer) once the cash is halfway out the senders mobile device the receiver MUST physically pull their PGUI e.g. transfer bar down pulling the cash into their mobile device. If the receiver does not physically accept the cash the transaction will time out and the cash will be retained in the Senders device and the SVK encryption key will be terminated or reconciled with a zero balance.
The physical requirement of both the sender and receiver to facilitate the transaction “just like cash” is the (embodiment) most crucial part of this provisional patent application.
Al could be enabled by the user to self-monitor their own pre-set criteria—results are not saved serer side and reports may be temporary snapshots into common activity for user awareness and confidence. The data the user chooses to retain is of their choosing in the add-ons to the application.
SVK's are transaction specific therefore to complete 5 transactions you need 5 keys on your device. Inward transactions reside in a separate folder than outward transactions ensuring all transactional balances over for example a possible $2000 are deposited into the chequing account upon server connection and future reconciliation. Reconciled SVK funds may flow through the users OIMT account into their chequing account or directly if pre-loaded credit cards or debit cards are incorporated into the SVK. Funds in the Pre-Reconciliation process may be available for use on the device prior to formal SVK reconciliation under certain circumstances.

### BACKGROUND OF INVENTION P10

PROBLEM:
This proprietary technology solves the problem of completing cash transactions in a cash-less society/nation during a major environmental event, emergency, disaster or governmental shift from physical currency.
This technology will help to reduce a run on the banks, panic and fear by the general population in times of disaster when the banking system is physically closed and when the banking systems servers and online data centers are rendered inoperable.
This technology may provide people with a small and regulated amount of cash that can be used to buy essential food and water during a crisis and should have a maximum amount that provides stability for the general population for at least X-days. (e.g. $2000 self-regulated maximum cash balance).
The suggested $2000 limit applies to the combined amount in the OIMT App & Account and there may also be a daily transfer limit.
Enabling two parties to transfer cash in cash-less society
Enabling a cash transaction to occur Offline without the need for internet, data or Wi-Fi
Enabling people to have cash available during a disaster or major power outage or pandemic
To prevent a run on the banks for cash when cash machines and the physical banks are deemed inoperable do to natural disaster, emergency, major power outage or pandemic.

OIMT bridges the gap between the current banking systems which requires data “Internet banking provides these services via the world wide web. The sector is also called E-banking, online banking, and net banking. Most other banks now offer online services. There are many online-only banks. Since they have no branches, they can pass cost savings onto the consumer.” (Ref: Kimberly Amadeo The Balance: https://www.thebalance.com/what-is-banking-3305812)—and enables users who would like to participate in modern banking on their device who do not have data available when away from home or who do not trust public Wi-Fi, or who desire an offline option or who value their privacy with a secure and private offline option for their cash like transactions. Prior to conducting an OIMT the user transfers money onto their device using existing money transfer technologies which require a connection to a network, bank servers, online, or other data dependant system. This OIMT technology foresees a network or server which could be available to users prior to an OIMT where users can download currency, cash, money, crypto from in advance of an Offline In-person Monetary Transfer (OIMT). SVK's must also be loaded onto the device in advance through a network/online connection before the user can conduct an Offline In-person Monetary Transfer (OIMT).

### SUMMARY OF INVENTION P

Post research and analysis of the digital financial and monetary transaction space the inventor has envisioned in part the next generation of peer-to-peer IN-PERSON, OFFLINE verified cash/currency transactions. (Offline In-person Monetary Transfer—OIMT)

Introducing two simultaneous physical motions on two separate mobile communications devices while within NFC range of each other or other short range communications; two humans must engage in a simultaneous monetary digital or data transfer—similar to cash. The salient aspect in the transfer of digital currency from one person to another person is the physical verification, and physical action and physical proximity required in addition the transfer can occur anywhere anytime and the devices do not need a connection to a server, data center, Wi-Fi, data or any other external source to facilitate and complete the monetary/data transfer as long as money and SVK's are pre-loaded on the communications devices; additionally the transfer does not require the sharing of any personal information between the two people.

Once an SVK is complete with the addition of the 3-4 additional numbers and or letters and or symbols either randomly generated or ‘made-up’ and imputed by the sender into the senders device before the transfer of money/data; the sender must give the ‘made-up’ or randomly generated digits of the SVK code to the receiver to enter in their device. Once the additional SVK digits are entered in the receivers device; the senders device will verify the SVK monetary/data transaction can occur with the receivers device and the senders device will then prompt the sender with a verification notification indicating the two devices are linked via Verified Key Lock (VKL) and a countdown timer will begin on both communication devices and the devices are ready for the Offline In-Person Monetary Transfer (OIMT) to be initiated by the sender; Person A (sender) using their mobile communication device slides a digital transfer bar (that looks like a volume bar) (PGUI—Physical Graphical User Interface {FIG. 2—Block 10})upward or pushes a button or swipes or performs any type of physical action upon their device as provided by the physical graphical user interface. This ‘required’ motion by Person-A occurs in conjunction with audible, visual and physical sensor and vibrational feedback to Person-A making Person-A aware of the money/data transfer OIMT (Offline In-Person Monetary Transfer) action they are initiating and completing. The Visual que to the sender occurs as they watch the monetary/data transfer virtually sliding out the top of Person A′s mobile communications device (FIG. 2—Block 11) and stops when 50% of the visual currency is remaining on Person-A′s mobile communications device. The visual virtual reference of the monetary or data transfer sliding out of Person A′s mobile communications device initiated a simultaneous visual, and audible que to Person-B (receiver) a visual virtual reference of the monetary transfer sliding into the top of their communications mobile device occurs (FIG. 2—Bloke 11b). Once 50% of the currency transfer has left Person-A′s device and has slid 50% of the way into Person-B′s device, Person B is now prompted by visual, physical and audible sensor feedback to physically slide down their transfer bar (push button or other graphical user interface) (FIG. 2—Block 10) while feeling physical sensor feedback and vibration affirming of the action they are conducting (FIG. 2f) in conjunction with the visual sliding of the money/data transfer sliding into their mobile communications device. While Person-B the receiver is sliding the money/data into their device Person-A continues to receive Visual, Audible and Physical sensor feedback until the money/data has completely slid out of their device and is 100% drawn into Person-B′s device. Both sender and receiver have a Cancel button (FIG. 2—Block 14) and are able to cancel the OIMT at any time prior to the receiver completing their physical slide of the transfer bar.

### SUMMARY OF INVENTION P2

PRIOR OF MONEY/DATA:
The user downloads the app onto their device
The user links the app with a participating financial/currency institution/company
The user transfers money from their account onto their device
The user downloads and or purchases Single-use Verified Keys (SVK) in the currency they wish to use
The user has both Money and SVK Keys on their device to send, or just keys to receive
The user sets up an account to pay any applicable fees
*It is envisioned that SVK's will be able to detect SVK's of other currencies and reconcile accordingly

UNIQUE IDENTIFIERS:
Single-use Verification Keys (SVK)/Validation Technology are:
Unique and randomly generated server side.
Single use and can only be used for one transaction
Logged as being used server side and can never be re-issued
Logged in a ledger, block chain, or other data storage method
Linked to the denomination transferred for reconciliation—Not linked to the other user.
Time limited upon the initiation of a transfer & terminated if not used within that time.
Multiple numbers and or letters and or symbols long with 3-4 digits being randomly created by the sender moments prior to initiating an OIMT and those digits randomly being incorporated into the SVK code.
Required by both the sender and receiver
Are purchased or are bundled as part of their fees from financial or currency institution/company.
Required for any transfer to occur
Require a data connection to be loaded on the device
Able to transfer monetary data between devices without a connection to an external server, mobile data, Wi-Fi, or other external 3^{rd} party.
Are stored separately on the device from monetary/data
Able to self-destruct either when timed out or by the physical cancelation of a transaction by either the Sender or receiver and or will be reconciled with a zero balance.
Currency specific—(The inventor Envisions SVK to be able to detect currencies and manage exchange rates and fees during reconciliation process.
Will help protect national Fiat currency's
Used to initiate the transfer of a nation's currency digitally
Able to verify other SVK's
Able to sit dormant until the additional digits of the key are randomly generated by the sender and only ‘link’ or ‘verify’ upon the receiver entering the aditional digits in their device and communicating the code for verification to the senders device. Only upon Verified Key Lock VKL on both devices are the keys ‘locked’ and the timer is initiated to complete the financial/data transfer
Able to provide a visual que, Audible noise and physical feedback to both the Sender and Receiver that they have pared and are ready for the monetary/data transfer.

### SUMMARY OF INVENTION P3

PHISICAL ACTIONS Required by Sender and Receiver:

Upon Verified Key Lock (VKL) a countdown clock commences. The transfer (OIMT) OFFLINE IN-PERSON MONETARY TRANSFER may be completed within the time allocated or the keys will destruct and the transaction will cancel and or reconcile with a zero balance.
The sender may physically touch the slide bar, button, or other visual transfer icon (PGUI: FIG. 2—Block 10) on the device via a graphical user interface. This interface could look like a volume bar (FIG. 2—Block 9) with a place to rest a finger or thumb to proceed with the transfer. It could be a random zig zag or other graphical motion that requires the user to slide their finger or thumb on the mobile communication device.
Once the transfer icon is touched by the sender Audible, Visual and Physical haptic feedback occurs letting the sender know they are initiating a monetary/data transfer (OIMT).
As the Sender Physically slides the (PGUI: FIG. 2—Block 10) transfer bar upward the audible noise from the device changes pitch; visually they see the money/data sliding (FIG. 2—Block 11) simultaneously toward and out the top of their device (or out either side or bottom) and the haptic Physical feedback intensifies , as the money/data is physical slid out of their device initiated by their own physical action.
As the Sender Physically slides the money/data out of their device the receiver visually watches and audibly hears the money/data enter their device (FIG. 2—Block 11b) from the top downward (or from side to side) once the money data is 50% in the receivers device they Physically touch their slide bar or other graphical user interface. Once touched they will receive PHYSICAL haptic sensor feedback as they slide the money/data. While the slide is occurring the receiver simultaneously and visually sees the money/data slide into their device while hearing an audible tone change pitch while they proceed with the Physical action of sliding the money data into their device as they complete the OIMT.
Once the action is complete both the Senders and Receivers device will show a message saying that the transfer is ‘complete’ (FIG. 2—Block 13) and their cash balance will be adjusted to reflect the new balance held on the device and in their account (FIG. 2—Block 16).
Once the action is complete the number of available keys available to the Sender and Receiver will update to account for the use of the keys used in the transaction (FIG. 2—Block 16).

### SUMMARY OF INVENTION P4

WHEN IS CELLULAR DATA, WIFI or a SERVER CONNECTION REQUIRED? (Pre and Post Transaction)
To download the app
To facilitate the purchase of Single-use Verification Keys SVK's or Validation Technology
To transfer cash/money/currency to the device from a financial/currency institution
To transfer cash/money/currency to a financial/currency institution from the device
To auto upload any incoming money/currency and associated SVK's to the users account on the input side for reconciliation and to upload and reconcile the outgoing money/currency on the senders side.
To pay fees, exchange rates or other charges
To auto offload a CASH-SVK's balance in access of the maximum allowable
To update SVK's and check their validity
To have the required pre-determined digital check-in with the financial institution be it once per week, day, hour, minute, second, millisecond, or manually initiated

WHEN CELLULAR DATA, WIFI or a SERVER CONNECTION IS NOT REQUIRED?
When SVK's (Single-use Verification Keys) are pre-loaded on a device the device can receive money/currency/data with no cellular data or Wi-Fi or server connection.
When money & country currency SVK's are pre-loaded on the device the device can both send and receive money/data.
When country currency SVK's are pre-loaded on a device and if the device has no existing money balance the device can receive money/currency data but cannot send money. The money received resides separately from money pre-loaded on the device used for purchases. (Therefore the money received and the associated SVK may work its way back to the users account for deposit before it can be used, this back loading of money requires a cellular/data connection to the server network and financial/currency institution)
Money can be sent without a cellular data or Wi-Fi/server connection as long as the money/currency and SVK's were first pre-loaded from the users financial/currency account onto the device in-advance of the OIMT (Offline In-person Monetary Transfer).

### SUMMARY OF INVENTION P5

The face-to-face in person NFC (Near-Field Communication) or similar short range transfer technology that REQUIRES both individuals to complete the OIMT (Offline In-person Monetary Transfer) transaction in close proximity similar to cash which requires random SVK code (additional numbers and or letters and or symbols) to be created by the sender IN-PERSON and the alignment of the DEVICES and PHYSICAL ACTION required by both Sender and Receiver to initiate, facilitate and complete the money/currency data transfer are elements of this technology.

ADDITIONAL TECHNOLOGICAL METHODS:
An option in some markets would be a dongle or separate physical electronic hardware device that plugs into the users mobile device that stores the, encrypted money/currency data.
An option in some markets would be a dongle or separate physical electronic hardware device that plugs into the users mobile device that stores the SVK or Validation Technology
An option in some markets would be a dongle or separate physical electronic hardware device that plugs into the users mobile device that stores the SVK or Validation Technology and Money/currency data
An option in some markets would be a dongle or separate physical electronic hardware device that wirelessly connects to the users' mobile device that stores the encrypted money/currency data.
An option in some markets would be a dongle or separate physical electronic hardware device that wirelessly connects to the users mobile device that stores the SVK or Validation Technology
An option in some markets would be a dongle or separate physical electronic hardware device that wirelessly connects to the users mobile device that stores the SVK or Validation Technology and Money/currency data

### SUMMARY OF INVENTION P6

AUTOMATED LEARNING, MACHINE LEARNING and ARTIFICIAL INTELEGENCE
Users will be able to purchase and download extensions to the app if they choose to self-monitor their transaction, create their own records. All data from these records or app extensions will reside in folders on the users device and there will be no mechanism created in the technology enabling the data collected via the users selection of various algorithmic and or learned technology to be uploaded to any 3^{rd} party servers or the primary servers for OIMT invention.
Should the pre-paid credit card or debit card technology be used by financial institutions separate data agreements would apply.
When SVK's are connected to Monetary/currency amounts via the incorporation of the 3 to 4 additional numbers and or letters and or symbols in the SVK these data sets will be stored on the financial institutions servers for reconciliation purposes, additionally, the two SVK's used in the transaction can sink with their associated financial/currency institutions/providers ledger, block chain or other data management software and cannot be linked to the associated key once an OIMT is complete. Similar to cash.
Unique user identifies including sensor data via machine learning and artificial intelligence, will help to prevent fraud by being able to identify unique characteristics of each user.

DATA
Data is required and collected for the purpose of tracking and accounting for withdrawals and deposits into and from the users' bank account for reconciliation purposes. The predetermined flow of money outlined in FIG. URES: 4 and 5, with a predetermined maximum cash balance is an embodied requirement to ensure the legal declaration of funds received by the user.
The data associated to the transfer of money from the users personal financial banking account to their communications device AND from the users communications device to their banking account will be tracked and monitored by their financial/currency institution.
All incoming funds work through the device in a predetermined sequence of sequential events and end up in the users Personal bank account.
All outgoing funds will be initiated from the users personal financial banking account and work down onto the users communications device.
Money received on the device cannot be spent and will not be added to the users available balance on their device as being available for spending. (Note: Certain Circumstances will allow the use of pre-reconciled funds see FIG. 5)
Data connection see reference pages “Possible Implementation and Administration” for a suggested flow of money.
NOTE: In National emergencies the government can permit financial institutions to enable a feature allowing funds received in the mobile communications device to be accessible for use prior to being uploaded and deposited into the OIMT Cash account and the users regular chequing account for reconciliation. (FIG.: 5)

### SUMMARY OF INVENTION P7

Optional: Pre-Reconciliation access to funds for Momentary OIMT Transfers

See FIG. 5: Pre-Reconciliation Flow Chart

The Pre-Reconciliation availability of funds may occur when a receiver receives funds on their device and chooses or is enabled to make those funds available for use prior to SVK server reconciliation. In this case:
OIMT (Offline In-person Monetary Transfer) may also be configured to allow funds received in the mobile communications device to be accessible for use prior to being reconciled and uploaded and deposited into the OIMT Cash account and or the user's regular chequing account.
In this scenario funds received may become immediately available for spending by the receiver through a process where the SVK attached to the incoming funds fall into a non-reconciled credit status.
To make funds available prior to reconciliation the user may maintain a minimum balance in their personal bank/currency/chequing account that may be drawn upon from their financial institution should the funds received and used in the Pre-Reconciliation process fail the reconciliation process after their device connects to the servers. (In national emergencies such as an earthquake this option may be enabled without a margin balance)
Failed SVK verification denominations through the Pre-Reconciliation process will be debited from the users account by the financial/currency institution.

### PREFERED EMBODIEMENTS

The System Architecture allows for ONLY 2 mobile communication devices to securely connect Offline through short range communication such as NFC (Near-Field Communication) (FIG. 2f—Block 31 & 33). The SVK (Single-Use Verification Key) uses multiple sensors such as but not limited to the light sensor, gyroscope sensor, GPS, accelerometer and biometrics etc . . . to aid in the verification process. In addition the sender creates additional SVK numbers, letters and or symbols to complete the SVK code, or uses the RNLSG (Random Number and or letter and or Symbol Generator). This code is not automatically sent to the receiver (The reason the SVK is not automatically sent is to ensure both parties are physically present within a few feet of each other). As part of the security process of insuring both sender and receiver are together the sender will show or audibly tell the receiver the additional SVK number, letters or symbols to enter in the receivers' device. The additional SVK Numbers letters and or symbols will be algorithmically placed or randomly placed in the SVK and each number letter or symbol may have a definition that constantly and randomly changes. The PGUI Physical Graphical User Interface requires both devices to be within close range e.g. centimeters of each (FIG. 2f —Block 33) other to link through short range communication such as NFC (FIG. 2f—Block 31). Upon VKL both users are prompted to facilitate the offline in-person monetary data transfer/ currency transfer within a set time limit (FIG. 2—Block 8). Both users can cancel the transfer at anytime with a cancel (FIG. 2—Block 14) button, or they can allow the timer to time out if they decide the do not want to complete the transfer. Finally either user can choose not to act upon the PGUI (FIG. 2—Block 10) which will also prevent the transfer from completing.

Key Embodiments Include, but are not limited to:

OIMT: Offline In-person Monetary Transfer

SVK: Single-Use Verification Key(s)

VKL: Verified Key Lock

PIPS Personal Identity Protective Software

PGUI: Physical Graphical User Interface

SDI: SVK-Dynamic Incorporation

RNLSG: Random Number Letter Symbol Generator

TIMER: Timer or Clock for which to complete transfer within

### SYSTEMS ARCHITECHTURE and SVK DYNAMIC INCORPORATION (SDI)

The System Architecture for the SVK envisions the online SVK development to be created server side on OIMT and or corporate servers where SVK's will be developed with specific purposes through an ability to enable or disable certain functions, systems, sensor inputs and verification methods depending on the final use. Use cases include direct use with certain financial institutions, currencies, challenger banks, and crypto currencies and exchanges. In addition features will enable SVK's for traditional financial institutions that can be downloaded directly by traditional financial institutions for direct client loading through existing banking portals further increasing user security and enhancing the reach of the OIMT invention. Portal access to OIMT servers for SVK validation will be done in non-identifiable means based on the security and verification measures built into the SVK's Personal Identity Protective Software (PIPS).

The SVK's ability to incorporate different payment methods including but not limited to prepaid credit cards through the existing credit card refund system and debit technologies (including Point of Sale terminals) will widen the SVK's technology reach and further enable those who are marginalized by current fintech offerings with the ability to participate in this modern OIMT fintech system without the need for data or sharing of personal information.

For prepaid credit cards the sender of cash would have the denomination linked to the SVK with an additional secure code embedded into their SVK relating to their bank through a randomized means utilizing the PIPS software. These SVK's will normally follow the standard SVK reconciliation process before being sent to the financial institution for an internal and final reconciliation. For those receiving funds on a pre-paid credit card the funds will be credited to their SVK as per the standard SVK protocol outlines in FIG. 5, however the funds will take an additional step after reconciliation and will be credited to the users account through the standard refund process currently adopted by the traditional banking industry.

### BRIEF DESCRIPTION OF FIGURES

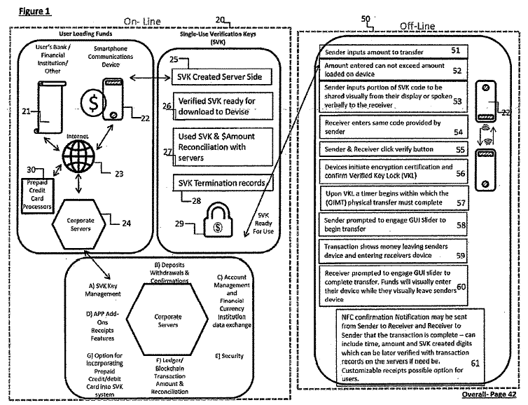

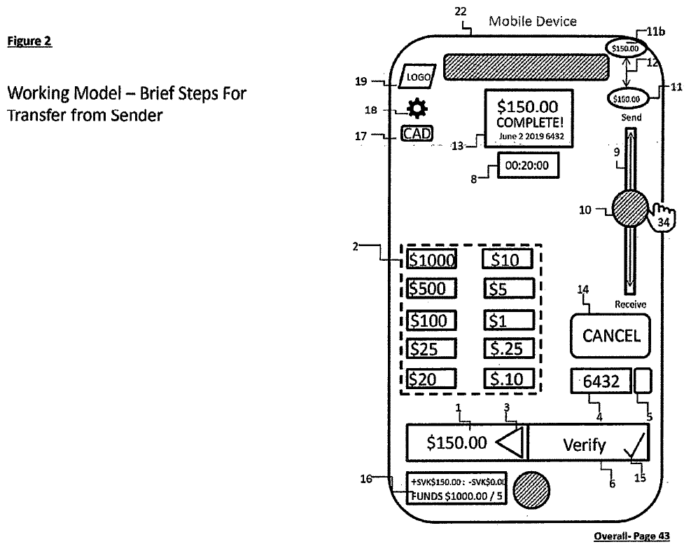

FIG. 1)
Shows what happens during the online and offline process to complete an OIMT (Offline In-person Monetary Transfer)
Shows when data is required for the loading of cash and SVK's.
Shows how the device connects to servers
Shows how SVK and Currency are loaded
Shows a macro picture of how the system architecture functions
Is a flow chart for how money flows into the device and how SVK's flow into/from the device.

FIG. 2)
Shows an overview of how all the features and system work on a mobile communications device.
The entire graphics package on the device can be reconfigured for left-handed use.

FIG. 2, 2c, 2e, 2f, 2g)
Shows the physical action required in-person offline to complete a transaction using the slide bar

FIG. 3)
Shows how a regular chequing account links and works with the OIMT (Offline In-person Monetary Transfer) system.

FIG. 4)
Shows:
   The flow of incoming funds
   The reconciliation of those funds in a ledger or Blockchain or other recording system
   The verification of the SVK linked to the funds received
   The flow of reconciled funds from the OIMT Cash account into the users regular financial account
   The flow of funds from the users regular chequing account to their OIMT Cash Account
   The flow from the OIMT Cash account to the Device ready for use

FIG. 5)
Shows how incoming money/currency can be spent pre-reconciliation. This is for use in emergencies or for those users who have margin with their financial/currency institution/company.

### DESCRIPTION OF DRAWINGS/FIGURES

WORKING MODEL DESCRIPTION: (FIGURES: 1, 2, 6)

SVK
SVK (Single Use Verification Key's) are generated server side and are available to download onto device using an internet connection and reside on device until they are required for a transaction.
SVK's are single use and can never be re-used or re-initiated should a mistake be made by the Sender or Receiver.
Only one SVK is used per transaction and the associated denomination entered is linked to that SVK for future reconciliation. Other data points such as date and time may be included in the ledger or transaction record server side.
SVK's must be pre-loaded onto both the devices over the internet for an OIMT to work offline.
When an amount for transfer is entered into the senders device and the SVK additional digits are also entered and the verify button is pushed. The receiver enters the same SVK additional digits and hits verify. Once the phones verify key lock over NFC or other short range communication a countdown timer will initiate for which the transfer must completed within.
The receiver may have a limited number of chances to enter the correct SVK e.g. 2 or 3 tries. If they are, unsuccessful the transaction will terminate and the SVK will terminate and register to the ledger or bank record with a zero balance or some other reference/indicating that the transaction did not occur.
Both Sender and Receiver will need to start over should the incorrect SVK entry code be entered or the time to complete the transfer runs out or if either the sender or receiver pushes a cancel button.
The SVK's additional code can be randomly incorporated into the SVK and when the receiver enters the additional 3-4 SVK digits they will be placed into the same location within the SVK during the VKL Verified Key Lock process or will be randomly entered into the SVK with other unique markers that can be identified during the reconciliation process.
The SVK's additional digits that are randomly generated either in person or by PRNG could relate to their location in the existing portion of the SVK code that the sender or receiver does not see. For example the random code chosen by the sender could be 6542. 6 may have a definition for its place in an SVK and 5 may mean the code is entered into the SVK in reverse. All additional SVK digits from 1-9 or letters from a-z or certain symbols may be randomly placed or have some element of individual security to make it difficult for an outside hacker to not only guess the additional SVK digits that the sender created but their subsequent location within the existing SVK.

### BRIEF DESCRIPTION OF DRAWINGS/FIGURES

WORKING MODEL DESCRIPTION (FIGURE: 2, 2A, 2B, 2C, 2D, 2E) DEVICE RECOGNITION
The two devices will recognize each other through the VKL Verified Key Lock Process. Some set of pre-determined encryption will allow one SVK to validate another SVK.
Each Device will be able to recognize the part of the SVK that is not visible to the user to authenticate the other Key is valid. Additional safeguards could be built into the app to recognize other devices using the app through NFC or other short range communication.
No personal information is shared between the 2 parties however an add-on may be available for a digital receipt to be generated separately that can be also shared.
A digital receipt may be included in the transaction outlining a the amount and the portion of the SVK key code or other unique identifier confirming the transaction completed on both devices that does not share any personal information.

Referring to FIG. 1 on Sheet 1:

20 Refers to the processes that require an internet or data connection

50 Refers to the process that are conducted off-line with no data connection Data

21 Is the Users participating Bank, Financial Institution or currency/crypto exchange

22 Users smartphone (Can be any NFC enabled devise and does not need to be a specific type of phone e.g. iPhone, Android etc..

23 The Word Wide Web where data is sent to Smartphones including Cash/Currency and SVK Single-Use Verification Keys from corporate/financial servers

24 Corporate Servers where the transactions are reconciled and verified for funds to be credited or debited. Can occur on institutional servers also.

24A SVK Management includes—Creation of Keys—Distribution of Keys—Reconciliation of Keys—Sending of Keys—Receiving of Keys

24B Deposits and Withdrawals are logged on the ledger, Blockchain or other transaction record for financial institution reconciliation process

24C User account Management including the loading and notification of Keys and the accessibility for general transaction records days/times/amounts

24D User ability to select and upload in app-purchases such as Receipt Manager, User Managed customizable data fields for user reference

24E SVK Key security validation requests, verifications, notifications and updates.

24F Post transaction information and SVK data is reconciled with server, ledger, Blockchain to verify accurate data and authenticate funds transfer

24G The option for SVK to include encrypted Prepaid visa information for offline monetary transfers using the refund process to fund the receivers account

25 SVK's are developed server side and have built in encryption technology that enables them to verify and transact with other SVK's generated on the server

26 Completed SVK's reside server side until they are requested for download to the users communication device

27 Incoming SVK's that were used in a transaction are uploaded to the server automatically from the user when a data/wifi connection occurs

27b Incoming SVK's reconcile with the server, ledger, or Blockchain and the data and amount of incoming or outgoing funds is sent to the financial institution for balance reconciliation

28 Any cancelled, timed out, or non- verified transactions that did not complete for any reason will register on the SVK as a zero balance and reconcile as such. There may be a notation in the reconciliation noting the transaction failed to complete or was cancelled by the user's

29 Once SVK's are ready for download onto the users device they remain dormant until a user loads them onto their device over the Internet

30) Possible inclusion of Prepaid credit cards into SVK through an encryption which enables in-person monetary transfers using the existing settlement system to fund the receivers account through the refund process. Funds would be removed from the sender upon reconciliation and the settlement process which occurs in the industry. Transactions are OIMT and protect privacy. Reconciliation occurs later when sender and receivers devices connect to the internet.

### DESCRIPTION OF DRAWINGS/ FIGURES

Referring to FIG. 2 on Sheet 2:

Working Model—Brief Steps For Transfer from Sender

[1 Funds Transfer Window] (Input funds here)

[Pre-Set Fund values] for quick entry into Funds Transfer Window

[3 Back Button]

[4 SVK additional character input window]

[5 SVK Random Number Generator selection button]

[6 VKL and Denomination Verify Button]

[7 VKL Verification] (See FIG. 1b)

[8 Timer or Clock]

[9 Slider bar]

[10 PGUI Physical Graphical User Interface]

[11 Visual Reference of Amount Being Sent]

[12 Direction indicator e.g. sending=up, receiving=down ]

[13 Transfer Confirmation Window and Receipt Verification] (if selected)

[14 Cancel Button]

[15 Funds and SVK Verification Confirmation Notification]

[16 Incoming and outgoing SVK amounts, Account Balance, Available SVK's]

[17 Currency Type, Crypto, Country, Other . . . ]

[18 Settings button]

[19 Company Logo]

[22 Mobile Communication Device]

[34 User Physical Action]

Referring to FIG. 2a on Sheet 3:

Working Model—Steps For Transfer from Sender

NOTE: Any form of PGUI (Physical Graphical User Interface) can facilitate the physical requirement for the users to engage in the OIMT (Offline In-person Monetary Transfer). This example shows a slider style bar [9 & 10] as an example of a possible PGUI the users can use to both send by sliding-up on the [10] volume style PGUI or receive by sliding down on this particular PGUI. The location where the user would place a thumb or finger to slide this example PGUI slider bar up to send or down to receive during the OIMT is on the dot indicated [10]. (NOTE: A left handed version could also be offered)

{[1] Funds Transfer Window} The sender enters the denomination to be sent (e.g. $150) either by selecting the input box [1] and using the device keyboard to type in the amount they would like to transfer or;

[2] by selecting a series of pre-selected denominations until the users desired denomination is inputted into the [1] funds transfer window;

{[2] Pre-set Transfer Amounts } E.g. Pre-set denomination amounts for quick entry of the amount of funds the user would like to transfer to the receiver. Multiple amounts can be selected to increase the amount a user would like to transfer.

{[3] back button} for corrections. Will go sequentially backwards for each tap of the button to the last amount entered or will erase the amount if the keyboard was used to enter a specific denomination.

{[4] SVK Input Window} Sender types in random set of number, letters, or symbols into the SVK window and shares the same code with the receiver to input in their SVK window. A standard keyboard will appear when the window

[4] is tapped.

{[5] SVK (Optional) Random Number Generator} Sender may choose to hit the RNG button to use a random number generator to create the additional SVK code if they choose to.

Referring to FIG. 2B on Sheet 4:

Working Model—Steps For Transfer from Sender

{[6] Verify Button } The sender hits the verify button after inputting the Funds to transfer and the SVK code. The transfer amount is confirmed as not exceeding the funds available and the additional code for the SVK is ready for VKL. (The verify button simply prepares the senders device to receive VKL (Verified Key Lock) from the receivers device and confirms the funds are available for transfer. A [15] check icon appears next to the verify button at this time.

{[4] SVK Code}

After the Sender communicates the additional SVK code to the receiver either by showing the receiver their device or by verbally sharing the SVK additional code numbers and or letters and or symbols with the receiver. The receiver enters the same SVK code into their devices GUI [4].

{[6] Verify Button} The Receiver then touches their Verify button after inputting the SVK code. The receivers device communicates the SVK to the Senders device and once the SVK's are confirmed both devices will VKL Verify Key Lock.

{[7] VKL Verification} Upon VKL the Senders and device shows the amount verified to transfer and a Verified confirmation. This confirmation represents successful VKL ‘Verified’ Key Lock.

{[7] Upon VKL the Receivers device shows the words [7] verified and may include the amount the sender plans to transfer to them.

{[8] Countdown Timer} Upon VKL e.g. a countdown timer or clock will initiate on both the sender and receivers device to indicate the amount of time the sender and receiver have to complete the OIMT (Offline In-Person Monetary Transfer). The timer is a visual reference and may also have an audible tone.

Referring to FIG. 2C on Sheet 5:

Working Model—Steps For Transfer from Sender

[9& 10] Example PGUI (Physical Graphical User Interface).

[9] Range of motion for [10] which is moved with the users physical contact e.g. thumb, fingers etc.

{[10] Upon VKL the senders slide bar can only SEND or be slid upward. In this example PGUI.

Once [8] countdown clock initiates after VKL The sender will be prompted to start the transfer with a either a physical and or audible and or visual representation.

The Sender must now Slide [10] up to the top of [9] which represents the physical action of Sending of funds, currency.

While the sender slides the e.g. PGUI the senders device may notify them of the Physical act they are doing via a visual, and or physical and or audible notification during their PGUI.

As the Sender acts upon, the [10] PGUI a {visual reference [11->11b]} will show the funds leaving the Senders devise. In this case going upward [12] toward the top of their device [11b].

Once the funds are at the top of [12] on the Senders device they will appear in the top of the receivers device also [11b];

Referring to FIG. 2D on Sheet 6:

Working Model—Steps For Transfer from Sender

Once the funds are at the top of [12] on the Senders device they will appear in the top of the receivers device also [11b];

[11b Visual Reference] Once the funds appear in the receivers device the receiver will be prompted via visual and or physical and or audible notifications to act upon their [10] PGUI to complete the transfer.

{[10] The Receivers PGUI e.g. slide bar can only RECEIVE or be slid downward to transfer funds, currency into their device.

While the Receiver slides the e.g. PGUI the receivers device may notify them of the Physical act they are doing via a visual, and or physical and or audible notification during their PGUI.

While the funds are visually sliding into the Receivers device [11b->11] as the receiver acts upon their PGUI the funds are disappearing out the top of the senders devise [12].

{[13] Once [10] the PGUI is slid all the way to the bottom a Transfer ‘COMPLETE!’ notification appears in the Verification window which may also include the date and SVK code as confirmation of a successful OIMT between the 2 users. Or another form of transfer verification may appear in this window. Upon completion the device may auto screenshot or the user can select how they wish to record the transaction.

{[14] Cancel Button} At anytime during the transfer (Prior to [13] COMPLETE!) the Sender or Receiver can hit the cancel button and cancel the transfer.

{[8] Countdown Timer/Clock} The Transfer will also Cancel if the [8]timer gets to zero before the transfer is [13] COMPLETE.

{[16] Possible hidden window that shows the SVK denomination sent or received awaiting reconciliation. This window also shows available funds and number of SVK's available for use.

Referring to FIG. 2E on Sheet 7:

Working Model Short Range Communication. E.g. NFC
NFC (Near Field Communications.

https://www.ionos.ca/digitalguide/server/know-how/nfc-near-field-communication/
{[31]NFC} and or other secure short range communications are essential to facilitating the “in-person” nature of the OIMT (Offline In-Person Monetary Transfer) NFC ensures the 2-devices are within inches of each other. The proximity of the 2-devices enables the sender and receiver to visually identify each other prior to conducting the OIMT.
[31] NFC or other secure short range communication can connect the phones while the SVK Single-use Verification Key encryption technology awaits VKL Verified Key Lock [7 FIG. 2b].
{[33] Effective Device Proximity for NFC communication} Approximate separation is a maximum of a few centimeters (+-2 cm) for NFC to function between devices ensuring each user is in contact with the correct person.
[10] Both users must act upon the [PGUI 10] Physical Graphical User Interface to complete a transfer. In this example the PGUI looks like a slider bar that resembles a volume style bar.
[32 Direction Sender would slide example PGUI 10] The [32] arrow represents the direction the sender would slide [10] to send funds to the receiver.
[32] The sender slides the example PGUI [10] to the Top of their device
[32b Direction Receiver would slide example PGUI 10] The [32b] arrow represents the direction the receiver would slide [10] to receive funds from the sender.
[32b] The receiver slides the example PGUI [10] to the bottom of their device.
{[34] User physical action} required upon [10 PGUI] to facilitate the sending and receiving of funds

Referring to FIG. 2F on Sheet 8:

Working Model During OIMT—Possible: Haptic, Audible, Visual feedback
{[35] Speaker} Device speaker may be used for both the [8 FIG. 2b] countdown clock and for audible feedback during OIMT upon PGUI [10] by users'.
{[36] Physical Vibration} Device may vibrate during OIMT upon PGUI [10] by users.
{[37 Visual Reference Condensed]} Condensed reference of
{visual reference [11->11b and 12]} See diagrams 2c and 2d

### DESCRIPTION OF DRAWINGS/FIGURES

Referring to FIG. 2G on Sheet 9:

Working Model

During OIMT—Possible: Additional Sensor Use
{[38] Light Sensor}] Each user could be prompted to cover their light sensor as an added layer of security to ensure the correct 2-devices are communicating with each other. Any Light sensor data could be stored in the SVK.
([39] GPS Sensor)] Each users device could use GPS coordinates to verify both phones are in close proximity of each other during OIMT, however this is not a requirement as this sensor may require data on some devices. Also GPS may be unavailable should the transfer be happening on another planet, outer space or ocean. Therefore this data is optional.
{[40 Gyroscopic Sensor]} The gyroscope sensor could be used to verify device orientation during the OIMT. As an added layer of security and SVK verification the Sender could request the receiver to position their device in a certain position prior to or during the OIMT.

Referring to FIG. 3 on Sheet 10:

Reconciliation of funds received is done using machine learning, AI, Blockchain or other ledger technology

(A & B) The combined OIMT Cash account and device cannot exceed $2000 of outgoing funds available—All incoming funds must reconcile and deposit in the users regular financial account.

ALL cash received on device must flow into the OIMT (Secondary) Chequing account (A) (and does not increase the funds available on the device) this occurs for reconciliation purposes. Funds must reconcile prior to being available for download and use on the mobile device.

Cash received will first flow into the receivers Device (B) and then the OIMT (secondary) account (A) for reconciliation and then after reconciliation flow into the users regular chequing account (C).

NOTE: All money going-out must originate from the clients regular checking account (C) and is kept separate from all incoming money that must first reconcile to be available for use.

NOTE: in National emergencies financial institutions can enable a feature allowing funds received in the mobile communications device to be accessible for use prior to being uploaded and deposited into the OIMT account and the users regular chequing account for reconciliation. This feature could also be enabled with a users margin account.

DESCRIPTION OF DRAWINGS/FIGURES

REFERING TO FIG. 6 on Sheet 13
The user downloads the app and registers with their financial or currency or crypto institution or exchange using Cellular/Wi-Fi or other Data.
The user loads money, currency data from their bank, financial institution, currency exchange, crypto company onto their device using internet cellular data/ Wi-Fi or other Data.
The user downloads SVK's to their device from a network using cellular data/ Wi-Fi or other Data.
The sender enters the amount either in the box provided or by touching the values until the amount they want to send is entered in the verify box. The sender clicks verify and the amount appears in the upper “Transfer” window.
The sender makes up a code (or it is PRNG generated) and enters it in their code window (Unique Data Set: UDS)
The sender shows the code to the receiver by showing them their phone or they speak the code to the receiving person.
The receiver enters the code in their device and clicks Verify
The code verifies that just those two devices are now linked and are ready to transfer money/data
The Sender places their thumb or finger on the transfer bar or other graphical user interface.
The sender slides the transfer bar upward. The sender visually sees the funds slide out their device hears audible feedback during the slide and feels physical haptic vibrations while sliding the transfer bar.
The receiver visually sees the money data entering their device
The receiver audibly hears an audible tone while this happens
When prompted the receiver touches their slide bar or other graphical user interface and physically slides the transfer bar to continue the visual process of money sliding into their device. While the receiver is sliding the money/data into their device they feel physical haptic vibrational feedback.
During and upon completion both devices provide visual, audible and physical acknowledgments confirming successful transfer has occurred.

### ADDITIONAL PGUI ELEMENTS ANTISPIATED

The PGUI could be in any form including the volume style slider bar as mentioned

Zig zag method of PGUI or circular PGUI

Swipe left or right or up or down PGUI is considered

Use of existing device hardware for physical elements such as tactile and virtual buttons. For example power button or up and down buttons.

Any method of Physically interacting with the device to physically send and receive funds during the OIMT

The incorporation of future GUI elements

Touchless swiping using sensors such as light sensors

The incorporation of standard GUI elements built into device

The incorporation of newly developed and future GUI elements

### ADDITIONAL SVK ELEMENTS ANTISIPATED

The incorporation of future encryption software

The incorporation of market ready encryption software

The licencing of 3^{rd} party encryption software

1. A method for performing a simultaneous OFFLINE IN-PERSON MONETARY (or data or currency) TRANSFER (OIMT) between two communications devices without the need for external servers, internet data, Wi-Fi or internet connection, the method comprising of:
Sender downloads money, currency and Single-use Verification Key's (SVK) onto device while connected to a network prior to an Offline in-person monetary transfer (OIMT);
Sender enters amount to be sent;
Sender inputs unique SVK numbers and or letters and or symbols;
Sender engages verification button to verify funds are available;
Sender audibly or visually shares numbers and or letters and or symbols in person with receiver (The additional. SVK Numbers and or Letters and or Symbols are not electronically sent to the receiver);
Receiver enters exact match of numbers, letters or symbols;
Two devices start communicating within a proximity of 12 inches;
Receiver activates verification button to determine an exact match with sender;
Devices now lock VKL;
VKL prompts sender to engage transfer;
Receiver is then prompted to respond;
Sender and Receiver see funds moving incrementally;
Upon transfer completion both devices acknowledge successful transaction.

2. The method of claim 1, further comprising the steps of: the initiation of a timer upon VKL in which the Offline In-person Monetary Transfer (OIMT) will be completed within.

3. The method of claim 1, further comprising the steps of: money, funds, currency and SVK's are to be pre-loaded on the communications device and or dongle using a data, Wi-Fi or an internet connection in advance of a an OIMT (Offline In-Person Monetary (data) Transfer)

4. The method of claim 1, further comprising the steps of: sender can use a Random number letter symbol generator for the additional SVK numbers and or letters and or symbols.

5. The method of claim 1, further comprising the steps of: sender thinks-up in their own mind a unique set of additional SVK numbers and or letters and or symbols as the additional SVK numbers and or letters and or symbols.

6. The method of claim 1, further comprising the steps of: the ability to send and receive money (or data, or any form of currency, crypto) in-person offline anywhere on the planet(s), ocean(s) or outer space(s) when both communication devices have SVK's and cash pre-loaded.

7. The method of claim 1, further comprising the steps of: the in-person validation and sharing of a unique set of numeric digits (and or letters and or symbols) that is to be added to the (4) SVK by both the sender and receiver in-person moments prior to (7) Verified Key Lock (VKL).

8. A method for verifying two communications devices over short range communication or NFC in-person using a Single-use Verification Key (SVK) that requires the sender to input the additional small number of numeric and or alpha and or symbol digits of the Single-use Verification Key (SVK) and physically or visually or audibly share the additional digits and or numbers and or alphas and or symbols in person with the receiver to enter in their device in preparation of Verified Key-Lock (VKL), comprising:
SVK's are created by a separate independent process;
SVK's are loaded by user when logged into their account;
Sender enters denomination and additional SVK letters and or number and or symbols in preparation of VKL;
Sender hits verification button for SVK to confirm funds are available on user device for transfer;
Receiver enters additional SVK letters and or numbers and or symbols communicated by sender;
Receiver initiates VKL by selecting the verify button;
Sender and receiver's SVK's lock during verification;
SVK's confirm additional SVK numbers and or letters and or symbols during verification;
SVK's link to a single transaction ONLY;
SVK's verify user by device/smartphone sensor and biometrics data;
SVK's verify device proximity with close range communication technology, such as NFC;
SVK's link between no more than two devices;
SVK′S link to the amount to be sent on senders device;
SVK′S link to the amount to be received on receivers device;
SVK's initiate VKL;
SVK's monitor VKL process;
OIMT occurs with close range communication technology, such as NFC;
SVK's monitor physical user PGUI interaction;
Failed OIMT transfers will reconcile SVK's with a zero debit balance on sender-side servers;
Failed OIMT transfers will reconcile SVK's with a zero credit balance on receiver-side servers;
If an OIMT SVK transfer fails to complete the SVK cannot be used again for any future transaction;
Failed OIMT SVK's will follow the same steps as a successful SVK but will reconcile with a zero balance;
SVK's confirm OIMT transfer is complete between sender and receiver;
Upon transfer completion both devices acknowledge successful transaction;
SVK's Link to denomination as debit or credit on device;
Upon successful transfer SVK's await server connection to begin reconciliation;
SVK's and the associated amount connect to servers and reconcile transaction on senders/receivers servers;
SVK's separate from amount transferred and are recorded in a ledger;
SVK's separate from amount transferred and the amount transferred is withdrawn from senders account;
SVK's separate from amount transferred and the amount transferred is deposited into receivers account;
SVK's are logged in a ledger as being used and cannot be used ‘ever again.

9. The method of claim 8, further comprising the steps of: SVK's link to a single transaction of any denomination during the OIMT or may be purchased e.g. with a pre-defined denomination set by the purchaser/user at the time of SVK purchase. (For example a purchaser could buy a $20 SVK or several SVK's with no pre-determined denomination.)

10. The method of claim 8, further comprising the steps of: the sender entering the monetary amount to be transferred to the receiver in the verification window; after which the sender must in-person physically enter an additional numeric and or alpha and or symbol digits e.g. 3 or 4 into the senders communication device finalizing the SVK code.

11. The method of claim 8, further comprising the steps of: the additional number of numeric and or alpha and or symbol digits of the SVK link to the monetary denomination entered in the senders’ device and record the monetary denomination amount being transferred for future balance reconciling upon a future internet, Internet data, wifi connection with the sender and receivers communications devices and their financial or other monetary or crypto or currency exchange institution(s).

12. The method of claim 8, further comprising the steps of: the additional number of numeric and or alpha and or symbol digits chosen by the sender being randomly incorporated into their SVK; The sender must then share in-person their chosen additional SVK small number of numeric and or alpha and or symbol digits with the receiver who then enters the exact same numeric and or alpha and or symbol digits in their device. Once the receiver enters the additional numeric and or alpha and or symbol digits into their SVK the receivers SVK links to the monetary or currency or crypto amount being transferred for future reconciling with servers upon an internet, internet data, Wi-Fi or data connection.

13. The method of claim 8, further comprising the steps of: the receiver entering the additional SVK small number of additional numeric and or alpha and or symbol digits, the receivers' device connects with the senders' device and awaits Verified Key Lock (VKL) from the senders' device.

14. A method for incorporating Simultaneous In-person Physical inputs to facilitate the transfer of money (or currency or crypto or data) between two communications devices using a slide bar or other physically enabled graphical user interface, the method comprising:
Upon VKL the PGUI is a volume style bar which requires user input to move;
As the Sender acts on the PGUI a visual representation of funds leaving their device occurs;
While the sender acts on their PGUI the receiver views a visual representation of funds entering their device;
Upon funds reaching the halfway mark in the receivers device they are prompted audibly and visually;
Receiver acts when prompted to transfer funds into their device;
Receiver slides volume style bar to transfer funds;
Receiver and sender both see visual representations of the funds entering or exiting their device;
Once the receiver completes the OIMT transfer their device confirms receipt;
The receivers device upon transfer completion sends the senders device a transaction confirmation;
Upon the sender receiving the receivers confirmation the senders device sends confirmation to the receiver.

15. The method of claim 14, further comprising the steps of: an exchange of funds/data between two communications devices that requires the physical simultaneous in-person interaction of both the sender upon their communication device and receiver upon their communication device to complete the transfer within possibly a specified period of time as indicated by a possible countdown clock by using NFC or other short range communications.

16. The method of claim 14, further comprising the steps of: the sender physically sliding a transfer bar that looks like a slider bar or volume bar or other user interface element e.g. up toward the top of their communications device.

17. The method of claim 14, further comprising the steps of: a visual graphic representing the funds leaving the senders device as they physically slide an e.g. slider bar or other user interface element.

18. The method of claim 14, further comprising the steps of: include a possible audible sound representing the funds leaving the senders device as they physically slide the slider bar or other user interface element.

19. The method of claim 14, further comprising the steps of: a possible physical haptic vibrational feedback to the sender as they e.g. slide the transfer bar or other user interface element and their money or currency or data or crypto into the receivers' communications device.
